(19) United States
(12) Patent Application Publication
(10) Pub. No.: US 2022/0363421 A1
(43) Pub. Date: Nov. 17, 2022

(54) CORRUGATED CARDBOARD BOX MAKING DEVICE, BOX MAKING METHOD, AND BOX MAKING AND PROCESSING METHOD

(71) Applicant: DAIO PAPER CORPORATION, Shikokuchuo-shi, Ehime (JP)

(72) Inventors: Masakatsu HORII, Odawara-shi (JP); Kazuya MORITA, Odawara-shi (JP); Kazushige TANABE, Odawara-shi (JP); Kenji HIYOSHI, Odawara-shi (JP)

(73) Assignee: DAIO PAPER CORPORATION, Shikokuchuo-shi, Ehime (JP)

(21) Appl. No.: 17/763,318

(22) PCT Filed: Sep. 25, 2020
(86) PCT No.: PCT/JP2020/036306

§ 371 Date: Mar. 24, 2022

(30) Foreign Application Priority Data
Sep. 27, 2019 (JP) 2019-178019
Oct. 3, 2019 (JP) 2019-183242

(51) Int. Cl. B65B 43/18; B65B 43/30; B65B 51/06

(52) U.S. Cl. CPC B65B 43/185; B65B 43/30; B65B 51/067

(57) ABSTRACT

A cardboard box production device includes: a stocker that holds a plurality of vertically stacked folded original boxes in a cardboard box having the top and bottom thereof open; a expansion provided upstream in a conveyance direction that is substantially orthogonal to the stacking direction of the original boxes, moving one side surface of an original box away from a first side on the stocker side towards a second side, and expanding the one side surface such that openings are formed at the top and bottom; a folding-in device that folds in the bottom of an open box opened upstream in the conveyance direction; a feeding device that feeds boxes from the upstream side in the conveyance direction to the downstream side; a conveyance belt; and an adhesion device that applies an adhesive tape to the bottom of the box in the conveyance area of the conveyance belt.

### TECHNICAL FIELD

The present invention relates to a corrugated cardboard box making device, a box making method, and a box making and processing method.

### BACKGROUND

Recently, mail order sales and the like have flourished, and according to this, the amount of the corrugated cardboard used has also increased. In addition, with regard to a size of the corrugated cardboard, a small-sized corrugated cardboard is also used in accordance with an increase of personal consumption.

In the case of the small-sized corrugated cardboard, it is more difficult to control the posture of a box during box making in comparison to a large-sized corrugated cardboard. In addition, control of box sealing (sealing) with an adhesive tape also becomes difficult.

For example, as one relating to satisfactory bottom assembly, Patent Document 1 can be exemplified.

### CITATION LIST

Patent Document

Patent Document 1: JP-A-2019-89270

### SUMMARY

A main object of the invention is to provide a corrugated cardboard box making device, a box making method, and a box making and processing method which are suitable for box making of a small-sized corrugated cardboard box.

According to an aspect of the invention, there is provided a corrugated cardboard box making device for making a corrugated cardboard box in which upper and lower sides are opened, including:

a stocker that holds a plurality of folded original boxes of corrugated cardboard boxes in a state in which the plurality of folded original boxes are placed in such a way that upper and lower sides thereof are positioned along a vertical direction and are stacked next to each other;

a development unit that is provided on an upstream side in a conveyance direction substantially orthogonal to a stacking direction of the original box;

a folding unit that folds a lower portion of the box developed at the upstream side in the conveyance direction;

a feeding unit that feeds the box from the upstream side to a downstream side in the conveyance direction;

a conveying belt unit that conveys the box to the downstream side while pressing both side surfaces of the box fed by the feeding unit; and

a sticking unit that sticks an adhesive tape to a bottom portion of the box in a conveyance region of the conveying belt unit.

According to another aspect of the invention, there is provided a corrugated cardboard box making device for making a corrugated cardboard box in which upper and lower sides are opened, including:

a stocker that holds a plurality of folded original boxes of corrugated cardboard boxes in a state in which the plurality of folded original boxes are placed in such a way that upper and lower sides thereof are positioned along a vertical direction and are stacked next to each other;

a development unit that is provided on an upstream side in a conveyance direction substantially orthogonal to a stacking direction of the original box, and develops the original box by moving one side surface of the original box from a first side that is the stocker side to a second side spaced apart from the first side in order for each opening to be formed on the upper and lower sides;

a folding unit that folds a lower portion of the opened box developed at the upstream side in the conveyance direction;

a feeding unit that feeds the box from the upstream side to a downstream side in the conveyance direction;

a conveying belt unit that conveys the opened box to the downstream side while pressing both side surfaces of the opened box fed by the feeding unit; and

a sticking unit that sticks an adhesive tape to a bottom portion of the box in a conveyance region of the conveying belt unit,

in which in the original box, portions corresponding to front and rear inner flaps and portions corresponding to right and left outer flaps are integrated in at least one of an upward surface and a downward surface in a box height, and

the development unit includes an air suction pad that suctions the portions corresponding to the outer flaps of the original box as the one side surface and reciprocates between the first side and the second side.

According to still another aspect of the invention, there is provided a corrugated cardboard box making method for making a corrugated cardboard box in which upper and lower sides are opened, including:

a process of holding a plurality of folded original boxes of corrugated cardboard boxes in a state in which the plurality of folded original boxes are placed in such a way that upper and lower sides thereof are positioned along a vertical direction and are stacked next to each other by a stocker;

a process of developing the original box by moving one side surface of the original box from a first side that is the stocker side to a second side spaced apart from the first side in order for each opening to be formed on the upper and lower sides by a development unit provided on an upstream side in a conveyance direction substantially orthogonal to a stacking direction of the original box;

a process of folding a lower portion of the opened box developed at the upstream side in the conveyance direction by a folding unit;

a process of feeding the box from the upstream side to a downstream side in the conveyance direction by a feeding unit;

a process of conveying the opened box to the downstream side while pressing both side surfaces of the opened box fed by the feeding unit by a conveying belt unit; and

a process of sticking an adhesive tape to a bottom portion of the box in a conveyance region of the conveying belt unit by a sticking unit.

According to still another aspect of the invention, there is provided a corrugated cardboard box making and processing method, for making a corrugated cardboard box in which upper and lower sides are opened, including:

a process of holding a plurality of folded original boxes of corrugated cardboard boxes in a state in which the plurality of folded original boxes are placed in such a way that upper and lower sides thereof are positioned along a vertical direction and are stacked next to each other by a stocker;

a process of developing the original box by moving one side surface of the original box from a first side that is the stocker side to a second side spaced apart from the first side in order for each opening to be formed on the upper and lower sides by a development unit provided on an upstream side in a conveyance direction substantially orthogonal to a stacking direction of the original box;

a process of folding a lower portion of the opened box developed at the upstream side in the conveyance direction by a folding unit;

a process of feeding the box from the upstream side to a downstream side in the conveyance direction by a feeding unit;

a process of conveying the opened box to the downstream side while pressing both side surfaces of the opened box fed by the feeding unit by a conveying belt unit;

a process of sticking an adhesive tape to a bottom portion of the box in a conveyance region of the conveying belt unit by a sticking unit;

a process of accommodating an accommodation object in the resulting corrugated cardboard box;

a process of sealing an upper surface of the corrugated cardboard box into which the accommodation object is accommodated with an adhesive tape;

a process of sticking a receiver's name label to the corrugated cardboard box; and

a reading process of reading information of the receiver's name label, in this order.

According to the invention, it is possible to provide a box making device and a box making method which are suitable for box making of a small-sized corrugated cardboard box.

### BRIEF DESCRIPTION OF THE DRAWINGS

FIG. 1 is a schematic plan view of a box making device example.

FIG. 2 is a perspective view illustrating an opening process in box making.

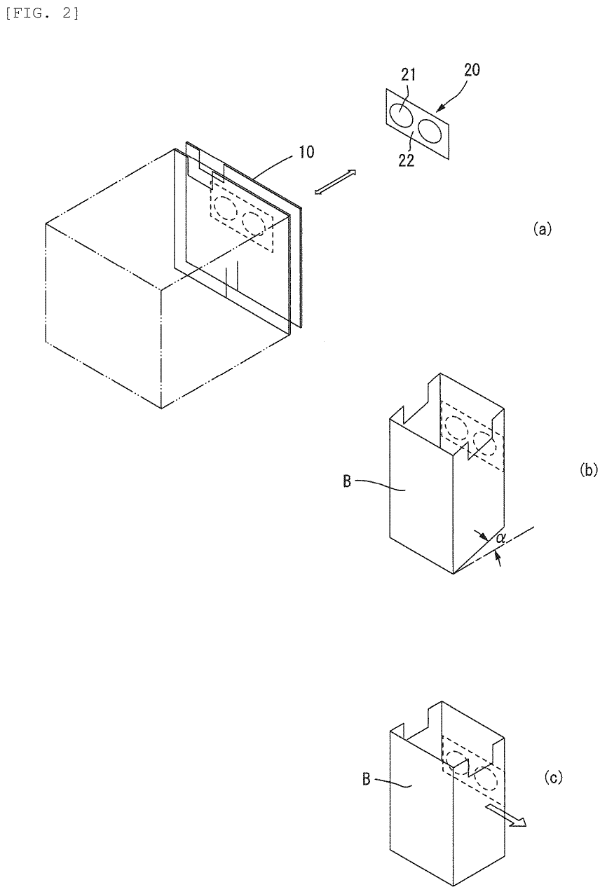

FIG. 3 is a perspective view illustrating pre-processing of a lower flap.

FIG. 4 is a perspective view of an opened box.

FIG. 5 is a perspective view for lower flap folding processing, and is a schematic plan view of a box making device example.

FIG. 6 is a view describing a pressed state of the lower flap.

FIG. 7 is a schematic front view of a main portion of the box making device example.

FIG. 8 is a front view of a conveying belt arrangement aspect.

FIG. 9 is a perspective view of a lower flap mismatching state of the opened box.

FIG. 10 is a development view of a thin corrugated cardboard box example.

FIG. 11 is a perspective view of a thin corrugated cardboard box with the lower flap sealed.

FIG. 12 is a perspective view of a previous step of performing sealing with respect to an upper flap.

FIG. 13 is a perspective view of a sealing state (an adhesive tape is not illustrated) of the thin corrugated cardboard box.

FIG. 14 is a perspective view for describing relating to dimensions of a target thin corrugated cardboard box.

FIG. 15 is a schematic plan view for describing a corrugated cardboard box making and processing method.

### DETAILED DESCRIPTION

Hereinafter, an embodiment of the invention will be described.

A box making device illustrated in the embodiment is suitable for a thin corrugated cardboard box having a small height, and is also applicable to box making of a corrugated cardboard box (hereinafter, also referred to as “connected flap type corrugated cardboard box”) in which flaps are not provided and upper and lower lids are folded to be described later, for example, as a development example of Japanese Utility Model Registration No. 3139567 in addition to a folded corrugated cardboard box (hereinafter, also referred to as “flap separation type corrugated cardboard box”) in which flaps are folded on upper and lower sides.

Accordingly, the box making device of the invention may be a dual-purpose device in addition to a dedicated device of one of the “flap separation type corrugated cardboard box” and the “connected flap type corrugated cardboard box”.

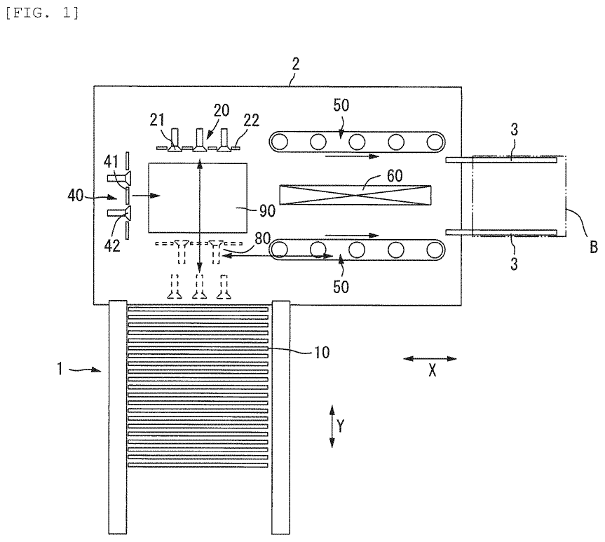

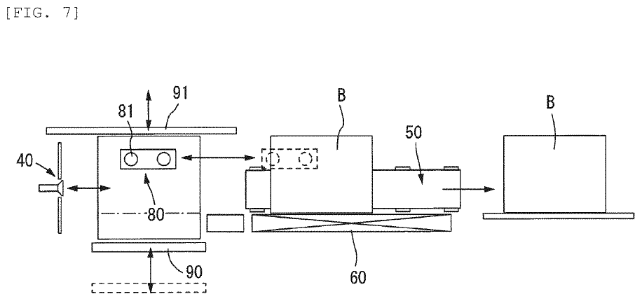

An overview of the corrugated cardboard box making device of this embodiment is typically illustrated in FIG. 1 and FIG. 7.

The box making device for making a corrugated cardboard box in which upper and lower sides are opened includes a stocker 1 that holds a plurality of folded original boxes 10 of the corrugated cardboard boxes in a state in which the plurality of folded original boxes are placed in such a way that upper and lower sides thereof are positioned along a vertical direction and are stacked next to each other.

As the stocker 1, a stocker having a known structure can be used as is.

In FIG. 1, a reference numeral 2 represents a box making main body portion, and a reference numeral 3 represents a box discharge guide.

A development unit 20 is provided on an upstream side in a conveyance direction X substantially orthogonal to a stacking direction Y of the original box 10.

Further, a folding unit 30 that folds a lower portion of a box B developed at an upstream portion in the conveyance direction X is provided, and a feeding unit 40 that feeds the box B from the upstream side to the downstream side in the conveyance direction X is provided.

A conveying belt unit 50 that conveys the box B to the downstream side while pressing both side surfaces of the box B fed by the feeding unit 40 is provided, and a sticking unit 60 that sticks an adhesive tape to the bottom portion of the box B in a conveyance region of the conveying belt unit 50 is provided.

Next, a specific example will be described.

The development unit 20 is configured to advance, and to recede after suctioning one side surface of the original box 10, and includes an appropriate number of air suction pads 21 reciprocating between a first side as a suction side and a second side as a receding side. A holding plate 22 is preferably provided to retain an elevation state by regulating one side surface of the suctioned original box 10. An appropriate movement mechanism can be used for the reciprocal movement, and a motor, a linear actuator, or the like can be used in addition to a cylinder.

As the folding unit 30 that folds a lower portion, for example, flaps of the developed box B at an upstream portion in the conveyance direction X, a known folding unit can be used.

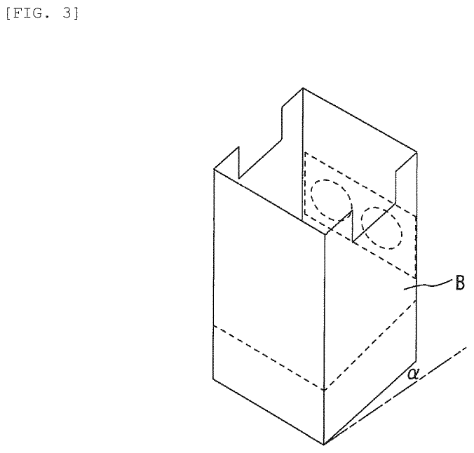

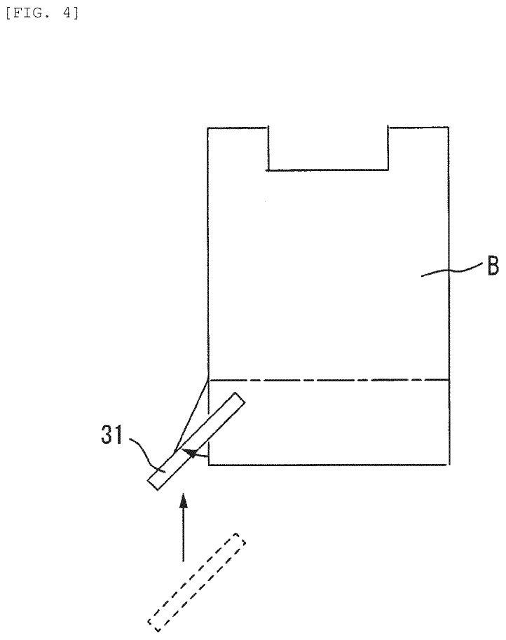

Although being developed by the development unit 20 as illustrated in FIG. 3, there is a tendency that an opening does not become a rectangular shape, and becomes a parallelogram as indicated by an angle α, and thus the folding unit 30 of this embodiment includes a flap flip-up bar 31 illustrated in FIG. 4. As illustrated in FIG. 4, the flap flip-up bar 31 ascends from a downward side, and flips up an outer flip of a side portion as preprocessing so that the subsequent folding is reliably performed.

At a point of time at which the preprocessing by the flap flip-up bar 31 is terminated, each of a plurality of the outer flips of a plurality of the side portions is folded due to rising of a folding roll 32.

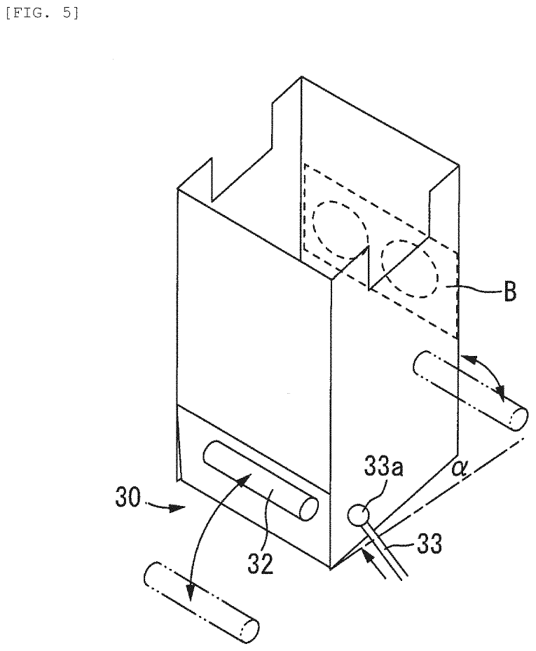

At this time, as illustrated also in FIG. 5, since a parallelogram tends to form at the angle α, in order to correct this, a pressing arm 33 is raised from a front side to push a front surface of an inner flap by a spherical body 33a located at a tip end. According to this, or with the help of feeding by the feeding unit 40 to be described later from a backward side, a square tubular box B is obtained, and folding of each outer flap by the folding roll 32 is reliably performed.

The folding roll 32 is held to an appropriate arm (not illustrated) to freely rotate, and the arm can be configured to cause the arm to perform an undulation movement.

As an undulation movement mechanism of the folding roll 32 and the pressing arm 33, a motor, a linear actuator, or the like can be used in addition to a cylinder.

As the feeding unit 40 that feeds the box from the upstream side to the downstream side in the conveyance direction X, a known feeding unit can be used.

At a point of time at which development of the box B is completed by the development unit 20, the feeding unit 40 of this embodiment advances along the conveyance direction X from a stand-by state after receding, and feeds a rear side of the developed box to a forward side.

A feeding plate 41 is provided for the feeding. Further, an appropriate number of air suction pads 42 are preferably provided to hold a rear surface of the box B and retain the right angle of the box in association with the development unit 20.

An appropriate movement mechanism can be used for reciprocal movement of the feeding plate 41 and the suction pad 42, and a motor, a linear actuator, or the like can be used in addition to a cylinder.

The box B fed by the feeding unit 40 is conveyed between conveying belt units 50 and 50 by the feeding unit 40.

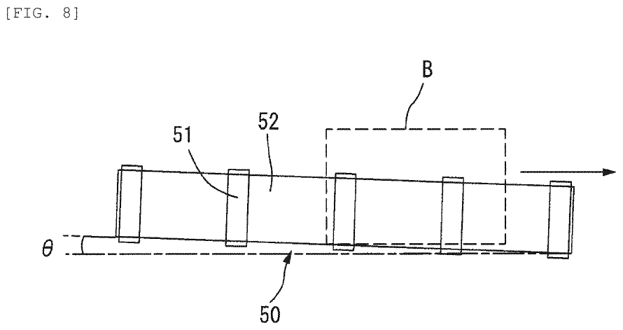

As the conveying belt units 50, a known conveying belt unit can be used. The conveying belt units 50 of this embodiment are wound around an appropriate number of conveying roller 51. As illustrated in FIG. 8, a conveying belt 52 is provided with a downward gradient at an angle θ toward a downstream side in the conveyance direction X.

The box B is conveyed to the downstream side while both side surfaces are pressed by the conveying belt units 50 and 50. The sticking unit 60 that sticks an adhesive tape 61 to the bottom portion of the box B is provided on a downward side of a conveyance region of the conveying belt unit 50.

As the sticking unit 60, a known unit can be used.

Since the conveying belt 52 is provided with a downward gradient at the angle θ (the angle θ is preferably 2° to 10°) toward a downstream side in the conveyance direction X, the box B that is conveyed is sequentially pushed down to a downward side. Accordingly, when sticking the adhesive tape 61 to the bottom portion of the box B by the sticking unit 60, a lower flap of the box B enters a state of being folded at the right angle with respect to the side surface (shape retention is high), and the adhesive tape 61 can be normally stuck.

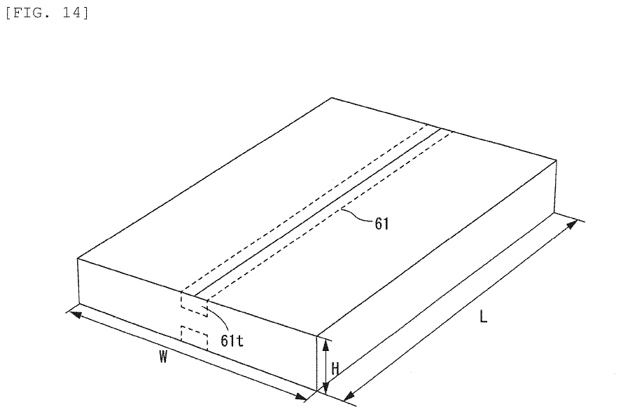

Particularly, in the case of a box with a low height, a length 61t extending to front and rear surfaces of the adhesive tape becomes short (refer to FIG. 14), and thus the downward gradient shape of the conveying belt 52 is effective to reliably fix the lower flap by the adhesive tape 61.

On the other hand, as described above, although being developed by the development unit 20 as illustrated in FIG. 3 or FIG. 5, there is a tendency that an opening does not become a rectangular shape, and becomes a parallelogram as indicated by the angle α.

Here, as described above, one of the side surfaces of the box B is supported by the development unit 20 including the air suction pads 21 and the holding plate 22 that regulates the one side surface of the suctioned original box 10 to retain the elevation state, and the rear surface of the box B is supported by the feeding unit 40 including the air suction pads 42 and the feeding plate 41. In this aspect, the box B can be retained in a right-angled rectangular parallelepiped shape, and thus this aspect is preferable.

On the other hand, even when the side surfaces and the rear surface can be regulated at the right angle, the box developed by the development unit 20 tends to be a parallelogram.

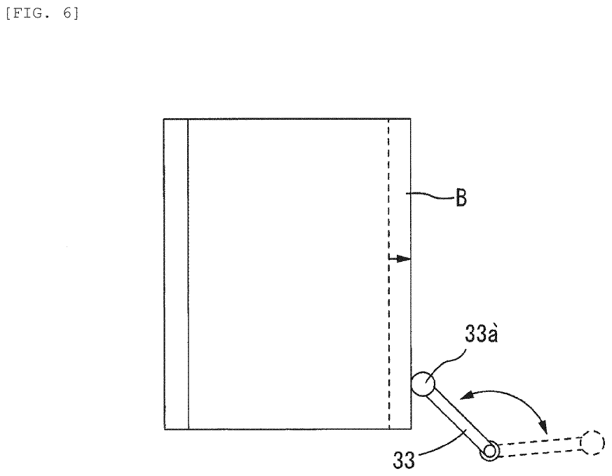

Here, as illustrated in FIG. 5 and FIG. 6, when the front surface is pushed rearward by the pressing arm 33, it is possible to regulate the shape to the rectangular parallelepiped shape.

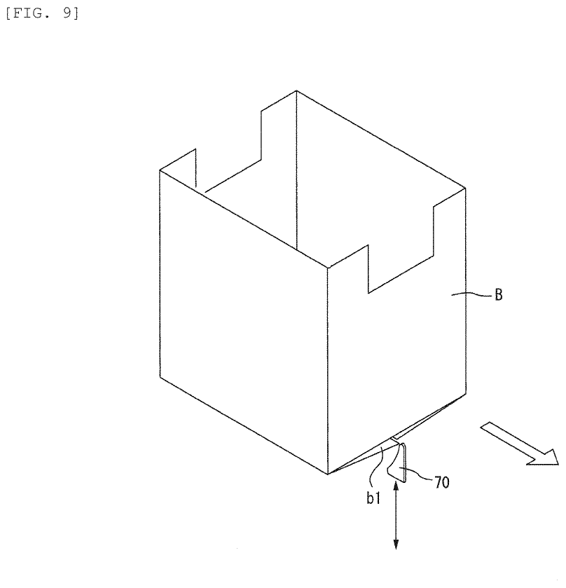

Further, in accordance with the tendency of being the parallelogram, a front edge of a lower outer flap b1 on the first side as the stocker 1 side tends to protrude forward in comparison to the front surface of the box B as illustrated in FIG. 9. When the box B is transmitted to the sticking unit 60 and the adhesive tape is stuck thereto, irregular sealing occurs.

Here, it is preferable to provide a regulation unit 70 that vertically moves up and down at a position facing the front edge of the lower outer flap b1 on the first side as the stocker 1 side. As the regulation unit 70, for example, a plate having an illustrated shape can be used, and a cylinder, a vertical movement mechanism by a linear actuator, an undulation mechanism by a plate rotation with a motor, and the like can be used for the vertical up and down movement.

After the box B is fed to a forward side by the feeding unit 40, and the front edge of the lower outer flap b1 comes into contact with the regulation unit 70, if feeding of the box B continues for a very short time while maintaining the contact state, the front edge of the lower flap b1 recedes, or the entirety of the box is corrected to the right angle.

At a correction termination point of time, the regulation unit 70 sinks downward.

Irregular sealing is prevented and normal sealing with the adhesive tape becomes possible by the regulation unit 70.

Note that, although the regulation unit 70 may also be provided on the second side, it is difficult to secure installation space in box making of a small box, and it is confirmed that installation on only the first side as the stocker 1 side is sufficient.

In a small box (or a thin box) having a low box height, a short length, and a short width, it is important for upper and lower opening edges in a development state to be horizontally retained, the box B has a rectangular parallelepiped shape, and the box B not to be inclined for the subsequent sealing.

Here, it is preferable that, as illustrated in FIG. 1, on the first side, after the original box 10 is moved from the stocker 1 to the conveying line side by the development unit 20, as illustrated in FIG. 7, a first side correction unit 80 that has been retracted to an upward side of the conveying belt unit 50 moves to a front side of the stocker 1 to correct an upper surface outer flap to an elevation state.

A movement mechanism such as a cylinder, a motor, and a linear actuator can be used for reciprocal movement of the first side correction unit 80 in a conveyance direction.

In the first side correction unit 80, a surface facing the upper outer flap may have a plate shape, and an appropriate number of air suction pads 81 can be provided, as necessary. When using the air suction pad 81, right and left surfaces can be retained in a state of being developed to the first side and the second side, and thus shaping of right-angled tubular box becomes easy.

In addition, it is preferable to provide a lower edge correction unit 90 that horizontally retains a level of an opening edge at a lower side of the box on an upstream portion in the conveyance direction after the original box 10 has been moved from the stocker 1 to the conveying line side by the development unit 20.

Particularly, in the case of the “flap separation type corrugated cardboard box”, since the lower flap is likely to be bent and the shape is likely to collapse in a vertical direction, the lower edge correction unit 90 that horizontally supports the entirety of the lower flap from a downward side is effective.

As the edge correction unit 90, a plate shape unit or the like can be used.

On the other hand, for example, when a plate-shaped lower edge correction unit 91 is provided on an upper side facing the lower edge correction unit 90, and the entirety of upper flaps are pressed downward and supported horizontally, the lower opening edge of the box B can be retained horizontally. This configuration is effective because an upright property of the box B can also be secured.

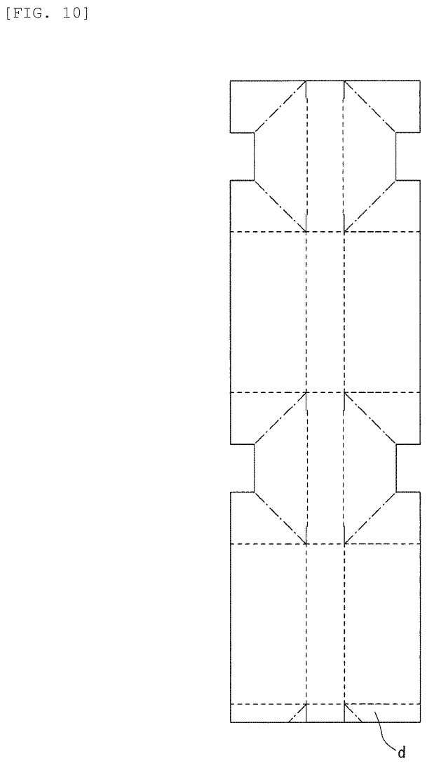

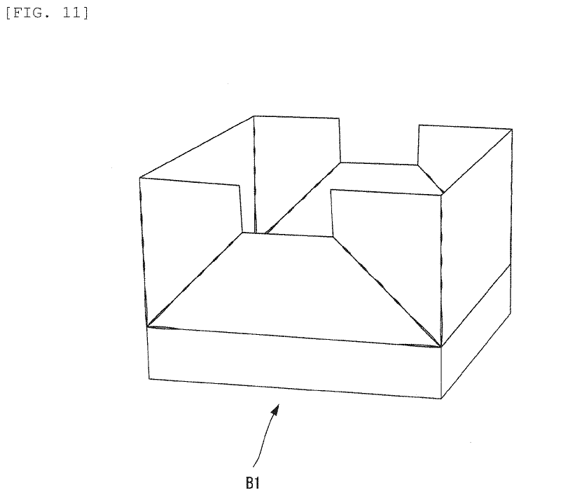

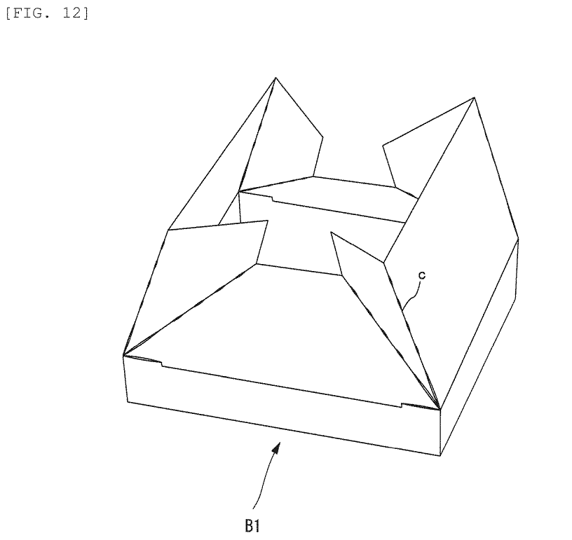

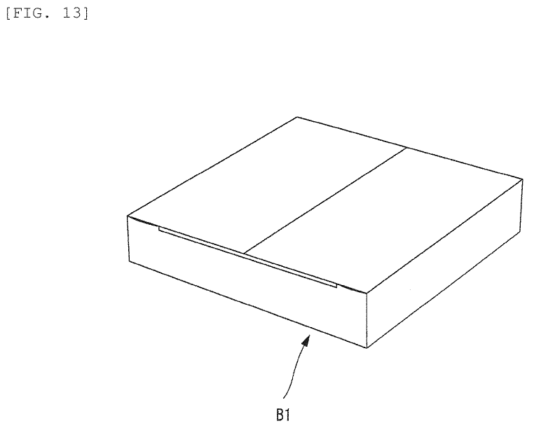

Next, description will be given of the “flap connection type corrugated cardboard box” with reference to FIG. 10 to FIG. 13. In the case of the “flap separation type corrugated cardboard box”, four-step flap folding is necessary, but according to the “flap connection type corrugated cardboard box”, folding is completed by two steps, that is, folding of an inner flap and folding of an outer flap, and thus there is an advantage that box sealing and box opening are simplified.

For example, the “flap connection type corrugated cardboard box” of an embodiment illustrated in the drawings is a development example of Japanese Utility Model Registration No. 3139567.

In a flap connection type corrugated cardboard box B1 illustrated in FIG. 10 to FIG. 13, an inner flap 2 and an outer flap 3 are integrated, and a sewing machine-like cut portion c is formed along a folding line with coarse intervals.

At the time of sealing, the flap connection type corrugated cardboard box B1 is provided in the stocker 1 in a state in which a joining portion d illustrated in FIG. 10 is joined and a square tube shape is flattened.

In the same manner, development and sealing of a lower surface are performed.

With regard to a structure of the flap connection type corrugated cardboard box B1, at an upward surface (upper surface) and a downward surface (bottom surface) in a box height, portions corresponding to front and rear inner flaps and portions corresponding to right and left outer flaps are integrated as necessary.

In addition to the illustrated example, at one of the upward surface and the downward surface in the box height, the portions corresponding to front and rear inner flaps and the portions corresponding to right and left outer flaps may be integrated.

In this case, the configuration in which the portions corresponding to front and rear inner flaps and the portions corresponding to right and left outer flaps are integrated at the upward surface in the box height is more preferable from the viewpoint of a flow of subsequent work of putting an object to be accommodated and of performing folding.

In the case of handling the flap connection type corrugated cardboard box B1, an aspect in which the upward surface in the box height is suctioned and retained by the development unit 20 is preferable.

In the case of the flap connection type corrugated cardboard box B1, since flaps are not individually displaced, the flaps are not inclined in a development process, and thus the flaps are likely to be horizontally retained.

Accordingly, box making is possible without using the above-described various correction units and various regulation units.

However, typically, a user also desires to perform box making of the flap separation type corrugated cardboard box without limitation to a box making device dedicated to the flap connection type corrugated cardboard box. Accordingly, it is preferable to provide the various correction units and the various regulation units.

The box making device of the invention is suitable for box making of a small-sized corrugated cardboard box.

For example, as the small-sized corrugated cardboard box, as sizes illustrated in FIG. 14, sizes within the following ranges are appropriate.

H: 20 to 80 mm (more preferably 20 to 50 mm, and particularly preferably 20 to 40 mm)

L: 140 to 300 mm (more preferably 180 to 250 mm)

W: 70 to 210 mm (more preferably 100 to 180 mm)

The corrugated cardboard box is used to carry luggage. It is necessary to specify a luggage destination after sealing.

Therefore, for example, an electronic tag can be used.

As is well known, an electronic tag (also referred to as an RF tag, an IC tag, an RF label, or the like) includes an IC chip and an antenna connected to the IC chip for performing storage and reading-out of information in a non-contact manner by near field communication. In addition, typically, the electronic tag has an adhesive surface as a rear surface for sticking to objects, or the electronic tag is applied to a product with a string or the like without the adhesive surface. Radio frequency identification (RFID) is an automatic recognition system that uses the electronic tag, and performs writing of information relating to luggage (objects) to which the electronic tag is attached and reading-out of information stored in the electronic tag through radio communication.

Various examinations and suggestions have been made on the electronic tag, and some are realized and some are not realized. For example, the electronic tag is expected to be applied to individual product management of products as an alternative to an optically readable tag such as a barcode. In Japan, the use of the electronic tag in specific retail businesses is known, but currently, the electronic tag is not used in a lot of retail businesses. The main reason for this is because the unit price of the electronic tag is high, but a reading accuracy related problem (blocking of radio waves due to water contained in the content of the product, a metallic product container, or the like), incompletion of a technology of attaching the electronic tag to individual products, and the like also become a hindrance to spreading.

However, the active use of the electronic tag has the potential of a product management revolution.

It is preferable to provide a conveying line that conveys a box making object that is an electronic tag attachment target, a tag attachment unit that attaches the electronic tag to which identification information is written to the box making object on the conveying line, and a reading device that reads the identification information written to the electronic tag from the electronic tag attached to the box making object on the conveying line on a downstream side of the tag attachment unit in the conveying line, and these components are used in the subsequent distribution.

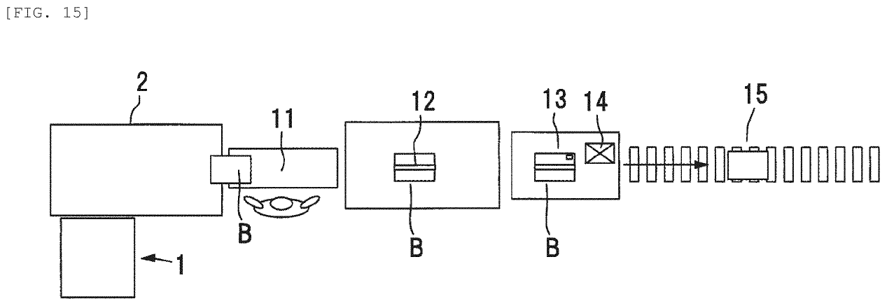

In a series of corrugated cardboard box making and processing, as illustrated in FIG. 15, it is possible to employ a corrugated cardboard box making and processing method including a process 11 of accommodating an accommodation object in the corrugated cardboard box B made into a box after the box making is terminated,

a process 12 of sealing an upper surface of the corrugated cardboard box into which the accommodation object is accommodated with an adhesive tape,

a process 13 of sticking a receiver's name label to the corrugated cardboard box, and

a reading process 14 of reading information of the receiver's name label, in this order.

The corrugated cardboard box that has undergone the reading process 14 is applied to distribution after a distribution process 15.

The electronic tag is attached to the receiver's name label, and thus the information written to the electronic tag can be read in the reading process 14.

### REFERENCE SIGNS LIST

1 Stocker
10 Original box
20 Development unit
30 Folding unit
40 Feeding unit
50 Sticking unit
60 Sticking unit
70, 80 First side correction unit
90 Lower edge correction unit
B Box
X Conveyance direction
Y Overlapping direction

1-9. (canceled)

10. A corrugated cardboard box making device for making a corrugated cardboard box in which upper and lower sides are opened, comprising:
a stocker that holds a plurality of folded original boxes of corrugated cardboard boxes in a state in which the plurality of folded original boxes are placed in such a way that upper and lower sides thereof are positioned along a vertical direction and are stacked next to each other;
a development unit that is provided on an upstream side in a conveyance direction substantially orthogonal to a stacking direction of the original boxes, and develops the original box by moving one side surface of the original box from a first side that is the stocker side to a second side spaced apart from the first side in order for each opening to be formed on the upper and lower sides;
a folding unit that folds a lower portion of the opened box developed at the upstream side in the conveyance direction;
a feeding unit that feeds the box from the upstream side to a downstream side in the conveyance direction;
a conveying belt unit that conveys the opened box to the downstream side while pressing both side surfaces of the opened box fed by the feeding unit; and
a sticking unit that sticks an adhesive tape to a bottom portion of the box in a conveyance region of the conveying belt unit.

11. The corrugated cardboard box making device according to claim 10,
wherein the development unit includes an air suction pad that reciprocates between the first side and the second side while suctioning the one side surface of the original box.

12. The corrugated cardboard box making device according to claim 10,
wherein a conveying belt of the conveying belt unit is provided with a downward gradient toward the downstream side of the conveyance direction.

13. The corrugated cardboard box making device according to claim 10,
wherein the feeding unit includes a plate that is substantially orthogonal to the conveyance direction.

14. The corrugated cardboard box making device according to claim 10,
wherein the feeding unit includes a plate that is substantially orthogonal to the conveyance direction and an air suction pad.

15. A corrugated cardboard box making method for making a corrugated cardboard box in which upper and lower sides are opened, comprising:
a process of holding a plurality of folded original boxes of corrugated cardboard boxes in a state in which the plurality of folded original boxes are placed in such a way that upper and lower sides thereof are positioned along a vertical direction and stacked next to each other by a stocker;
a process of developing the original box by moving one side surface of the original box from a first side that is the stocker side to a second side spaced apart from the first side in order for each opening to be formed on the upper and lower sides by a development unit provided on an upstream side in a conveyance direction substantially orthogonal to a stacking direction of the original boxes;
a process of folding a lower portion of the opened box developed at the upstream side in the conveyance direction by a folding unit;
a process of feeding the box from the upstream side to a downstream side in the conveyance direction by a feeding unit;
a process of conveying the opened box to the downstream side while pressing both side surfaces of the opened box fed by the feeding unit by a conveying belt unit; and
a process of sticking an adhesive tape to a bottom portion of the box in a conveyance region of the conveying belt unit by a sticking unit.

16. A corrugated cardboard box making and processing method for a corrugated cardboard box in which upper and lower sides are opened, comprising:
a process of holding a plurality of folded original boxes of corrugated cardboard boxes in a state in which the plurality of folded original boxes are placed in such a way that upper and lower sides thereof are positioned along a vertical direction and stacked next to each other by a stocker;
a process of developing the folded original box by moving one side surface of the original box from a first side that is the stocker side to a second side spaced apart from the first side in order for each opening to be formed on the upper and lower sides by a development unit provided on an upstream side in a conveyance direction substantially orthogonal to a stacking direction of the original boxes;
a process of folding a lower portion of the opened box developed at the upstream side in the conveyance direction by a folding unit;
a process of feeding the box from the upstream side to a downstream side in the conveyance direction by a feeding unit;
a process of conveying the opened box to the downstream side while pressing both side surfaces of the opened box fed by the feeding unit by a conveying belt unit;
a process of sticking an adhesive tape to a bottom portion of the box in a conveyance region of the conveying belt unit by a sticking unit;
a process of accommodating an accommodation object in the resulting corrugated cardboard box;
a process of sealing an upper surface of the corrugated cardboard box into which the accommodation object is accommodated with an adhesive tape;
a process of sticking a receiver's name label to the corrugated cardboard box; and
a reading process of reading information of the receiver's name label, in this order.

17. The corrugated cardboard box making and processing method according to claim 16,
wherein an electronic tag is attached to the receiver's name label, and in the reading process, information written to the electronic tag is read.
